(19) United States
(12) Patent Application Publication
(10) Pub. No.: US 2026/0360032 A1
(43) Pub. Date: Nov. 12, 2026

(54) IMAGE PROCESSING APPARATUS

(71) Applicant: KYOCERA Document Solutions Inc., Osaka (JP)

(72) Inventor: Takanori Murashima, Osaka (JP)

(21) Appl. No.: 19/177,153

(22) Filed: Apr. 11, 2025

(30) Foreign Application Priority Data
Apr. 18, 2024 (JP) 2024-067303

(51) Int. Cl. G06T 11/60; G06T 7/70; G06V 30/148; G06V 30/28

(52) U.S. Cl. CPC G06T 11/60; G06T 7/70; G06V 30/148; G06V 30/287; G06T 2207/20084; G06T 2207/30176

(57) ABSTRACT

An image processing apparatus includes a document image acquiring unit, a text information extracting unit, a prompt generating unit, a generated image acquiring unit, and a document image editing unit. The document image acquiring unit is configured to acquire a document image. The text information extracting unit is configured to perform a character recognition process for the document image and thereby acquire from the document image text data of a text described in the document image. The prompt generating unit is configured to generate a prompt for a predetermined image generation model on the basis of the acquired text data. The generated image acquiring unit is configured to acquire a generated image corresponding to the generated prompt. The document image editing unit is configured to add the acquired generated image in the document image.

### CROSS-REFERENCE TO RELATED APPLICATIONS

This application relates to and claims priority rights from Japanese Patent Application No. 2024-067303, filed on Apr. 18, 2024, the entire disclosures of which are hereby incorporated by reference herein.

### BACKGROUND

### 1. Field of the Present Disclosure

The present disclosure relates to an image processing apparatus.

### 2. Description of the Related Art

An image generation AI service such as Stable Diffusion generates an image corresponding to an inputted text (i.e. prompt).

An information processing method uses an image generation AI service and thereby generates an advertising image on the basis of advertising information (company name, product name, or the like).

For the aforementioned image generation AI service or image generation AI, a user is required to input a proper text (i.e. proper prompt) for obtaining an image desired by the user. When a user wants to add an automatically-generated image to a document image, a proper text (proper prompt) may not be chosen and thereby a proper image may not be added due to a level of proficiency of the user.

### SUMMARY

An image processing apparatus according to an aspect of the present disclosure includes a document image acquiring unit, a text information extracting unit, a prompt generating unit, a generated image acquiring unit, and a document image editing unit. The document image acquiring unit is configured to acquire a document image. The text information extracting unit is configured to perform a character recognition process for the document image and thereby acquire from the document image text data of a text described in the document image. The prompt generating unit is configured to generate a prompt for a predetermined image generation model on the basis of the acquired text data. The generated image acquiring unit is configured to acquire a generated image corresponding to the generated prompt. The document image editing unit is configured to add the acquired generated image in the document image.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing apparatus according to an embodiment of the present disclosure;

FIG. 2 shows a diagram that indicates an example of a document image;

FIG. 3 shows a diagram that explains a text extracted from the document image shown in FIG. 2;

FIG. 4 shows a diagram that indicates an example of text data used to generate a prompt among plural pieces of text data of lines shown in FIG. 3;

FIG. 5 shows a picture that indicates an example of a generated image that was generated using a string “hamburger” as a prompt specified by a user;

FIG. 6 shows a picture that indicates an example of a generated image that was generated using a string “hamburger” as a prompt specified by a user and strings: “Lunch”, “Menu” (in Japanese), “dish” (in Japanese), and “plus”; and

FIG. 7 shows a diagram that indicates an example a document image that a generated image has been added.

### DETAILED DESCRIPTION

Hereinafter, an embodiment according to an aspect of the present disclosure will be explained with reference to drawings.

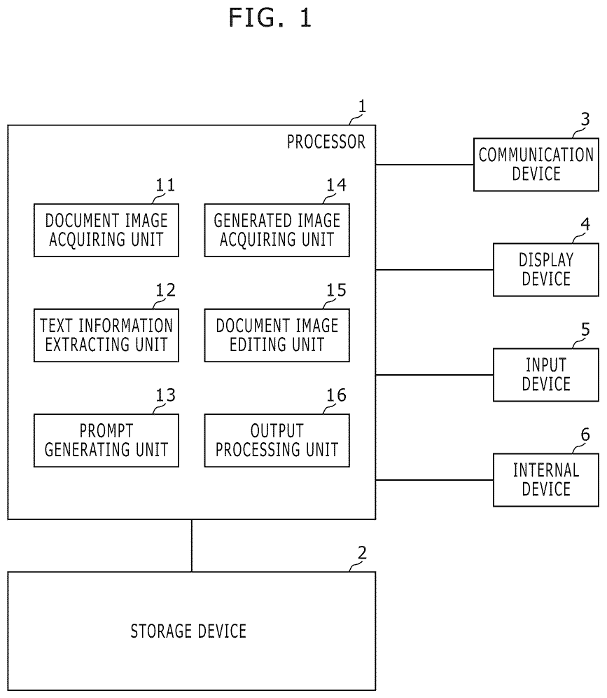

FIG. 1 shows a block diagram that indicates a configuration of an image processing apparatus according to an embodiment of the present disclosure. An image processing apparatus shown in FIG. 1 is an information processing apparatus such as personal computer, or an electronic apparatus such as digital camera or image forming apparatus (scanner, multi function peripheral or the like), and includes a processor 1, a storage device 2, a communication device 3, a display device 4, an input device 5, an internal device 6 and the like.

The processor 1 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 2, executes the program with the CPU, and thereby acts as sorts of processing units. Further, the processor 1 may include an ASIC (Application Specific Integrated Circuit) that acts as a specific processing unit.

The storage device 2 is a non-volatile storage device such as flash memory, and stores the image processing program and data required for a process mentioned below. In the storage device 2, setting data and the like are stored.

The communication device 3 is a device that performs data communication with an external device, such as network interface or peripheral device interface. The display device 4 is a device that displays sorts of information to a user, such as a display panel of a liquid crystal display. The input device 5 is a device that detects a user operation, such as keyboard or touch panel.

The internal device 6 is a device that performs a specific function of this image processing apparatus. For example, if this image processing apparatus is an image forming apparatus, the internal device 6 is an image scanning device that optically scans a document image from a document, a printing device that prints an image on a print sheet, and/or the like.

Here, the processor 1 acts as a document image acquiring unit 11, a generated image acquiring unit 12, a prompt generating unit 13, a generated image acquiring unit 14, a document image editing unit 15, and an output processing unit 16.

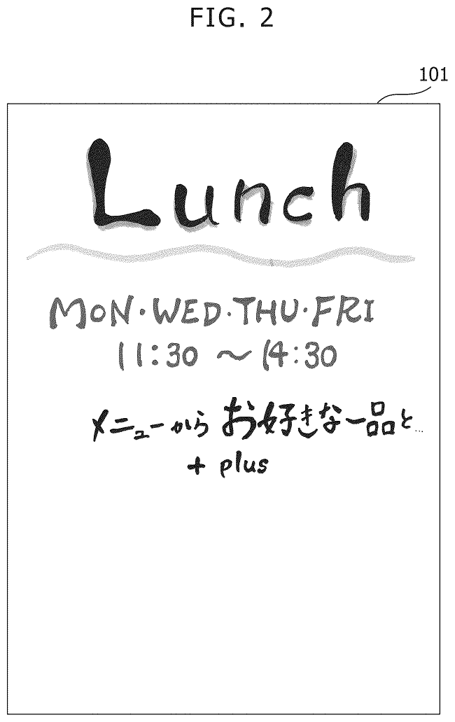

The document image acquiring unit 11 acquires a document image (i.e. image data of it) of a document from the storage device 2, the communication device 3, the internal device 6 or the like, and stores the document image into the RAM. For example, this document is a print product outputted by a printing device, and this document image is an image obtained by scanning such document using an image scanning device. For example, this document is a flyer or the like. FIG. 2 shows a diagram that indicates an example of a document image. A document image 101 shown in FIG. 2 includes a text of plural lines.

The text information extracting unit 12 performs a character recognition process for the document image and thereby acquires from the document image (the document image 101 as shown in FIG. 2, for example) text data of a text described in the document image. The prompt generating unit 13 generates a prompt (input string) to be inputted to a predetermined image generation model on the basis of the text data acquired by the text information extracting unit 12.

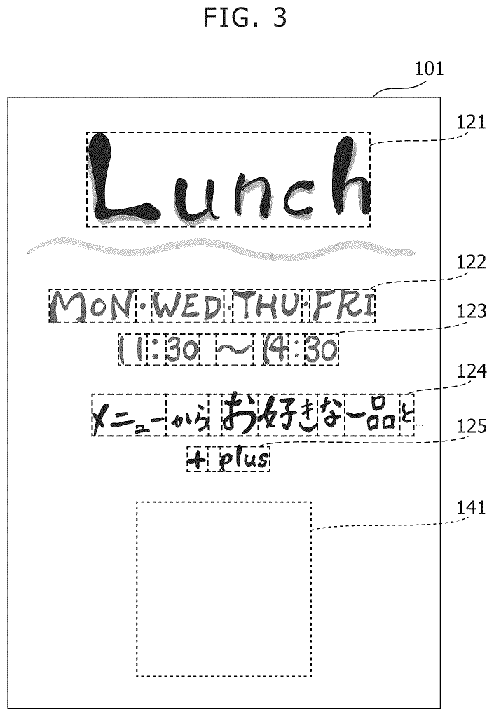

FIG. 3 shows a diagram that explains a text extracted from the document image shown in FIG. 2. Here, the text information extracting unit 12 (a) determines for each text in the document image a position at which the text is described, with the aforementioned text data, and (b) classifies the text data line by line on the basis of the position as shown in FIG. 3. Here, as shown in FIG. 3, line bounding boxes 121 to 125 are determined for lines, respectively.

Further, the text information extracting unit 12 determines a characteristic of the text in the document image, and the prompt generating unit 13 selects text data on the basis of the determined characteristic among the acquired text data, and generates the prompt on the basis of the selected text data.

Here, for example, this characteristic of the text is a size of the text, and the prompt generating unit 13 selects text data of a line of which a text has a largest size among the acquired text data, and generates the prompt on the basis of the selected text data. Here, a word (noun or the like) in the text data of the line is extracted and included into the prompt. For example, a height of the line bounding box i (i=121, . . . , 125) shown in FIG. 3 is determined as the size of the text.

Further, the characteristic of the text may include at least one of characteristics of the text: a character type, a font, a color, a slant, a width of a character gap, and a width of a line gap.

Furthermore, as show in FIG. 3, for example, an image addition area 141 to which the generated image should be added is set in the document image 101. The image addition area 141 may be described in the document image 101 in advance or may be set on the basis of a user operation to the input device 5. The prompt generating unit 13 generates the prompt on the basis of text data of a line within a range of a predetermined distance from the image addition area 141 among the acquired text data. Here, a word (noun or the like) in the text data of the line is extracted and included into the prompt.

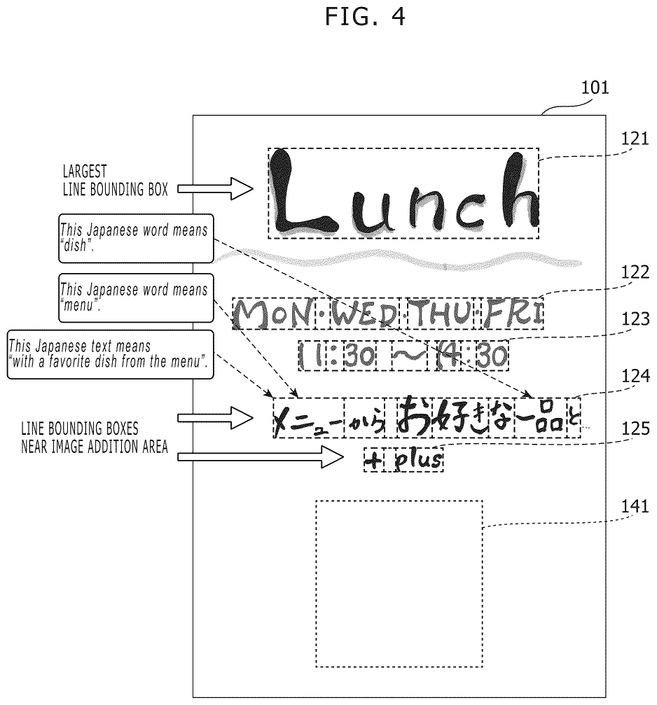

FIG. 4 shows a diagram that indicates an example of text data used to generate a prompt among plural pieces of text data of lines shown in FIG. 3. For example, as shown in FIG. 4, the aforementioned text data of a line of which a text has the largest size and the text data of a line near the image addition area 141 are used to generate the prompt. Therefore, among the acquired text data, text data other than the text data of the lines selected as mentioned is not used to generate the prompt.

For example, in a case shown in FIG. 4, “Lunch”, Japanese word #1 (that means “Menu” in English), Japanese word #2 (that means “dish” in English) and “plus” are obtained from the selected line text data “Lunch”, Japanese text #1 (that means “with a favorite dish from the menu” in English), and “+plus”. FIG. 4 includes the Japanese text, but alternatively may include an English text only.

Further, the prompt generating unit 13 may include a string desired by a user into the prompt. For example, the string is specified by a user operation to the input device 5, such as “hamburger” that indicates an object of which a user wants to include into a generated image.

Further, the prompt generating unit 13 may generate the prompt from the aforementioned string using a large language model such as GPT (Generative Pretrained Transformer). For example, the prompt generating unit 13 may access an external server using the communication device 3, input the aforementioned string into a large language model on the external server, and acquire a text as the prompt from the large language model on the external server.

The generated image acquiring unit 14 acquires a generated image corresponding to the generated prompt.

For example, the generated image acquiring unit 14 may include a leaner for an image (image generation model) for which machine learning has been performed, and may generate the generated image corresponding to the generated prompt using the learner; and alternatively, may access an external server using the communication device 3, input a prompt into such a learner (image generation model) on the external server, and acquire a generated image from the learner (image generation model) on the external server.

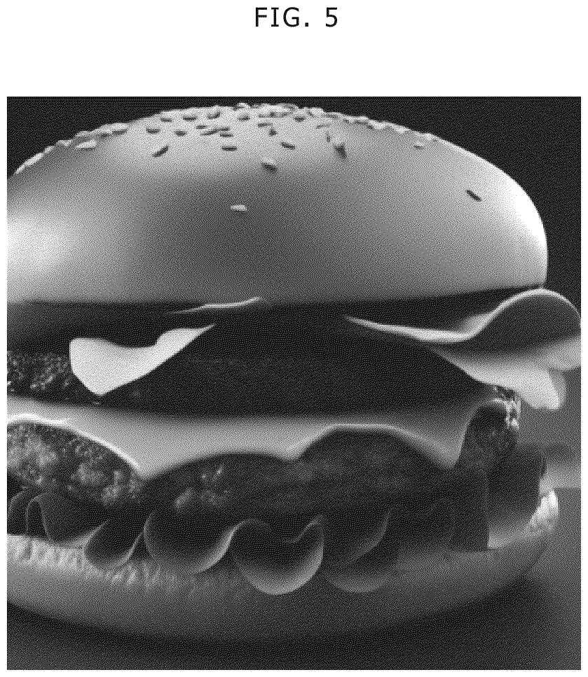

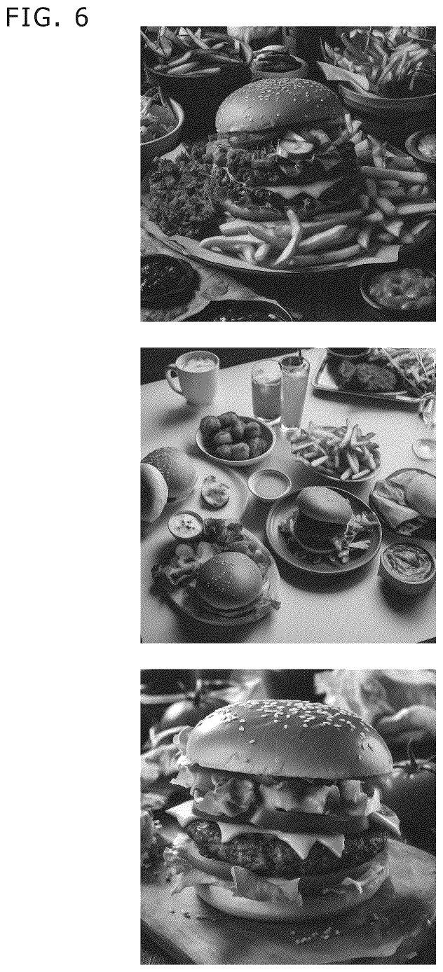

FIG. 5 shows a picture that indicates an example of a generated image that was generated using a string “hamburger” as a prompt specified by a user. FIG. 6 shows a picture that indicates an example of a generated image that was generated using a string “hamburger” as a prompt specified by a user and strings: “Lunch”, “Menu” (in Japanese), “dish” (in Japanese), and “plus”. The generated images shown in FIGS. 5 and 6 are actually generated by an image generation model, and the actual images are generated as color images.

For example, from “hamburger”, “Lunch”, “Menu” (in Japanese), “dish” (in Japanese) and “plus” (as shown in FIG. 4), the large language model generates plural prompts such as “Lunch menu featuring a hamburger” (in Japanese), “Hamburger menu with side menus and drinks available” (in Japanese), and “All hamburger menus with hearty portions” (in Japanese), and plural generated images corresponding to these prompts are obtained as shown in FIG. 6. Here, the generated images shown in FIG. 6 were generated using the prompts in Japanese, but same or similar images can be generated using the prompts in English.

The document image editing unit 15 adds the acquired generated image in the document image. Here, the image addition area is set in the document image, and the document image editing unit 15 attaches the generated image to the image addition area. The image addition area may be specified by an instruction object in the document image or may be specified by a user operation to the input device 5. When attaching the generated image to the image addition area, if required, zooming or trimming of the generated image may be performed to match a shape of the generated image with a shape of the image addition area.

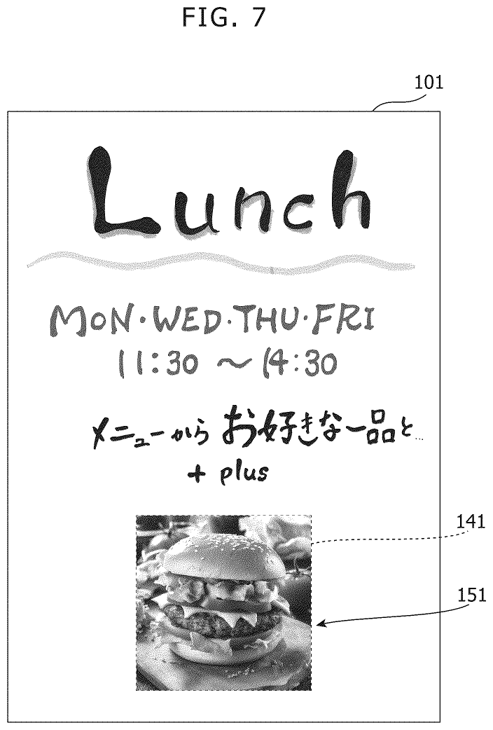

FIG. 7 shows a diagram that indicates an example a document image that a generated image has been added. If the generated image acquiring unit 14 acquires plural generated images corresponding to the aforementioned prompts as mentioned, the document image editing unit 15 may select a generated image specified by a user among the acquired plural generated images, and add the selected generated image in the document image. In such a case, for example, the document image editing unit 15 displays a list of the plural generated images as shown in FIGS. 5 and 6, and selects a generated image from the list on the basis of a user operation to the input device 5, and attaches the selected generated image 151 to the image addition area 141 as shown in FIG. 7, for example.

The output processing unit 16 performs outputting (printing, data transmission, data saving and/or the like) of the document image edited by the document image editing unit 15.

The following part explains a behavior of the aforementioned image processing apparatus.

Firstly, the document image acquiring unit 11 acquires image data of a document image from the storage device 2, the communication device 3, the internal device 6 or the like. The text information extracting unit 12 performs a character recognition process for the acquired document image and thereby acquires from the document image text data of a text described in the document image.

Subsequently, the prompt generating unit 13 generates a prompt (input string) for a predetermined image generation model on the basis of the text data acquired by the text information extracting unit 12 as mentioned.

Subsequently, the generated image acquiring unit 14 acquires a generated image corresponding to the generated prompt, and the document image editing unit 15 adds the acquired generated image into document image. The output processing unit 16 performs outputting of the document image edited by the document image editing unit 15.

As mentioned, in the aforementioned embodiment, the text information extracting unit 12 performs a character recognition process for a document image and thereby acquires from the document image text data of a text described in the document image. The prompt generating unit 13 generates a prompt for a predetermined image generation model on the basis of the acquired text data. The generated image acquiring unit 14 acquires a generated image corresponding to the generated prompt. The document image editing unit 15 adds the acquired generated image in the document image.

Consequently, an image desired by a user is added to a document image on the basis of text information in the document image.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, an importance level (numerical value larger than 0 and equal to or less than 1) may be derived of each of the strings to be included in the prompt in accordance with a predetermined rule on the basis of the characteristic of the text determined by the text information extracting unit 12, and the prompt may be generated by specifying the importance level with the string to the aforementioned large language model. Further, in such a case, a threshold of the importance level may be set, and the prompt may be generated using the aforementioned large language model without a string that has an importance level less than the threshold value and with a string that has an importance level equal to or larger than the threshold value. The aforementioned rule may include a rule that a higher importance level is set for a specific color (e.g. catchy color such red) than that for the other colors, and/or a rule that an importance level of a string is set correspondingly to a density (brightness) of the text, a size of the text and/or the like.

In such a case, information that a user focuses on is extracted on the basis of the characteristic of the text described in the document image, and a prompt according to the information is generated, and consequently, a generated image according to the information is acquired.

What is claimed is:

1. An image processing apparatus, comprising:
a document image acquiring unit configured to acquire a document image;
a text information extracting unit configured to perform a character recognition process for the document image and thereby acquire from the document image text data of a text described in the document image;
a prompt generating unit configured to generate a prompt for a predetermined image generation model on the basis of the acquired text data;
a generated image acquiring unit configured to acquire a generated image corresponding to the generated prompt; and
a document image editing unit configured to add the acquired generated image in the document image.

2. The image processing apparatus according to claim 1, wherein the text information extracting unit (a) determines a position at which the text is described, with the text data from the document image, and (b) classifies the text data line by line on the basis of the position; and
the prompt generating unit generates the prompt on the basis of text data of a line within a range of a predetermined distance from an image addition area to which the generated image should be added, among the acquired text data.

3. The image processing apparatus according to claim 1, wherein the text information extracting unit (a) determines a position at which the text is described, with the text data from the document image and further determines a characteristic of the text in the document image, and (b) classifies the text data line by line on the basis of the position; and
the prompt generating unit selects text data on the basis of the characteristic among the acquired text data, and generates the prompt on the basis of the selected text data.

4. The image processing apparatus according to claim 3, wherein the characteristic is a size of the text; and
the prompt generating unit selects text data of a line of which a text has a largest size among the acquired text data, and generates the prompt on the basis of the selected text data.

5. The image processing apparatus according to claim 3, wherein the characteristic includes at least one of characteristics of the text: a character type, a font, a color, a slant, a width of a character gap, and a width of a line gap.

6. The image processing apparatus according to claim 1, wherein the prompt generating unit includes a string desired by a user into the prompt.

7. The image processing apparatus according to claim 1, wherein the generated image acquiring unit acquires plural generated images corresponding to the generated prompt; and
the document image editing unit selects a generated image specified by a user among the acquired plural generated images, and adds the selected image in the document image.
